(19) United States
(12) Patent Application Publication
(10) Pub. No.: US 2004/0178050 A1
(43) Pub. Date: Sep. 16, 2004

(54) Neutral sensing switch for remote vehicle starter

(76) Inventor: Jonathan Wylde, Mississauga (CA)

Correspondence Address: HODGSON RUSS LLP, ONE M & T PLAZA, SUITE 2000, BUFFALO, NY, 14203-2391, US

(21) Appl. No.: 10/698,542

(22) Filed: Oct. 31, 2003

Related U.S. Application Data
(60) Provisional application No. 60/423,979, filed on Nov. 6, 2002.

(51) Int. Cl. H01H 9/06; F16H 59/00

(52) U.S. Cl. 200/61.88; 74/335; 74/473.12

(57) ABSTRACT

The invention is directed to a neutral sensing switch for use with a remote vehicle starter to prevent the vehicle starter from starting a vehicle unless the shift lever for the transmission is in the neutral position. The neutral sensing switch includes a transmitter mounted on top of a shift lever which transmits a signal generally towards a receiver. The transmitter and receiver are both connected to a processing circuitry of a controller. Based on the signal detected by the receiver, the controller determines whether the shift lever is in the neutral position.

This application claims priority to U.S. Provisional Patent Application Serial No. 60/423,979 filed on Nov. 6, 2002.

### FIELD OF THE INVENTION

The present invention relates to remote vehicle starters, and more particularly to a neutral sensing switch for remote vehicle starters for use with vehicles equipped with manual transmission systems.

### BACKGROUND OF THE INVENTION

Remote vehicle starters are generally used in inclement climates to permit the operator to start the vehicle from a distance, thereby allowing the vehicle's engine to reach an optimal operating condition and the climate control systems to reach an adequate comfort level prior to the operator using the vehicle.

Various remote vehicle starters have been proposed in the past. However, most prior systems are geared towards vehicles using automatic transmission systems and are not readily adaptable for vehicles with a manual transmission. Remotely starting a vehicle having a manual transmission may have catastrophic results if the vehicle's transmission is not in the neutral position, for the vehicle may lunge forward or backward and cause injury to bystanders or objects in its path. However, when the vehicle transmission is in the “neutral” position, the driveshaft is disconnected from the transmission gears, and the vehicle can be safely started without it moving from the parked position.

A number of remote starting systems have been developed to overcome the problem of starting a manual transmission vehicle remotely. However, these systems have a number of disadvantages, as they tend to be quite complex, are awkward and costly to install and calibrate, are cumbersome to operate for the end user, and due to their complexity, are prone to misalignment and false readings. In addition, most prior remote start systems are not equipped with a mechanism to prevent remote starting a vehicle when the vehicle is already in motion.

### SUMMARY OF THE INVENTION

The present invention provides a neutral sensing switch for use with a remote vehicle starter which addresses the shortcomings associated with known systems.

The present invention arises from the realization that the existing remote starters for vehicles equipped with manual transmission systems are difficult to install, require frequent calibration, and are prone to false reading while detecting the neutral position of the transmission system. The present invention seeks to alleviate the problem of misdetection of the neutral position in the existing remote vehicle starters by providing a neutral sensing device having a transmitter mounted on a shift knob handle of a shift lever which transmits a signal towards a receiver. The transmitter and receiver are both connected to a processing circuitry of a controller. Based on the signal detected by the receiver, the controller determines whether the shift lever is in the neutral position and communicates this information to a remote car starter for igniting the vehicle's engine. In the event that the vehicle is in motion during the start-up, a vehicle movement sensor terminates the remote start-up procedure in the event the vehicle is not in a stationary position.

In one example, there is provided a sensing switch for detecting the position of a vehicle transmission shift lever having a shift lever knob at an upper end thereof. The sensing switch includes a receiver having a predetermined target area, and a transmitter for transmitting a directed beam of trigger signals. One of the receiver and transmitter is mounted to the shift lever knob and the other of the receiver and transmitter is mounted in the vehicle at a location spaced apart from the shift lever knob so that the transmitted trigger signals are directed towards the target area when the shift lever knob is in a predetermined position. A controller is coupled to the receiver for determining, based on the trigger signals received by the receiver, if the shift lever knob is in the predetermined position and if so generating a predetermined signal.

In another example, the present invention provides a sensing switch for detecting the position of a transmission shift lever in a vehicle. The sensing switch includes a receiver having a predetermined target area, the receiver being configured for mounting to a target area in the vehicle, a shift knob handle having embedded therein a transmitter for transmitting a directed beam of trigger signals and having a lower end for engaging an upper end of a shift lever, and a controller coupled to the receiver for determining, based on the trigger signals received by the receiver, if the shift lever is in the predetermined position and if so generating a predetermined signal.

In yet another example, the present invention provides a neutral sensing system for use with a remote vehicle starter in a manual transmission vehicle to detect of the vehicle is in neutral. The system includes a sensing switch for determining, upon receiving an activating signal, if a transmission shift lever is in a predetermined physical location that is associated with neutral, and if so generating a “start” signal to signal the remote vehicle starter to commence starting the vehicle engine, and a movement detection device for detecting, upon receiving an activating signal, if the vehicle is moving, and if so generating a “kill engine” signal to override the “start” signal and cause the vehicle starter to abort starting the vehicle engine.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Reference will now be made to the accompanying drawings, which show, by way of example, representative embodiment of the present invention, and in which:

FIG. 1 is a diagrammatic view of a representative embodiment of the neutral sensing switch according to the present invention;

FIG. 2 is a diagrammatic view the neutral sensing switch transmitter mounted on a vehicle's shift lever knob according to an embodiment of the present invention;

FIG. 3 is a graphical representation of trigger pulses generated by the neutral sensing switch transmitter;

FIG. 4 is a diagrammatic view of the internal components of the neutral sensing switch according to an embodiment of the present invention;

FIG. 5 is a diagrammatic view of the internal components of a neutral sensing switch according to another embodiment of the present invention;

FIG. 6 is a diagrammatic view of the internal components of a neutral sensing switch according to another embodiemnt of the present invention; and

FIG. 7 is a flow chart showing the sequence of steps undertaken by a remote car starter in cooperation with the neutral sensing switch of the present invention.

### DETAILED DESCRIPTION OF EXAMPLE EMBODIMENTS

The present invention is now described with reference to accompanying drawings, wherein similar elements and features are designated by like reference numerals throughout the drawings.

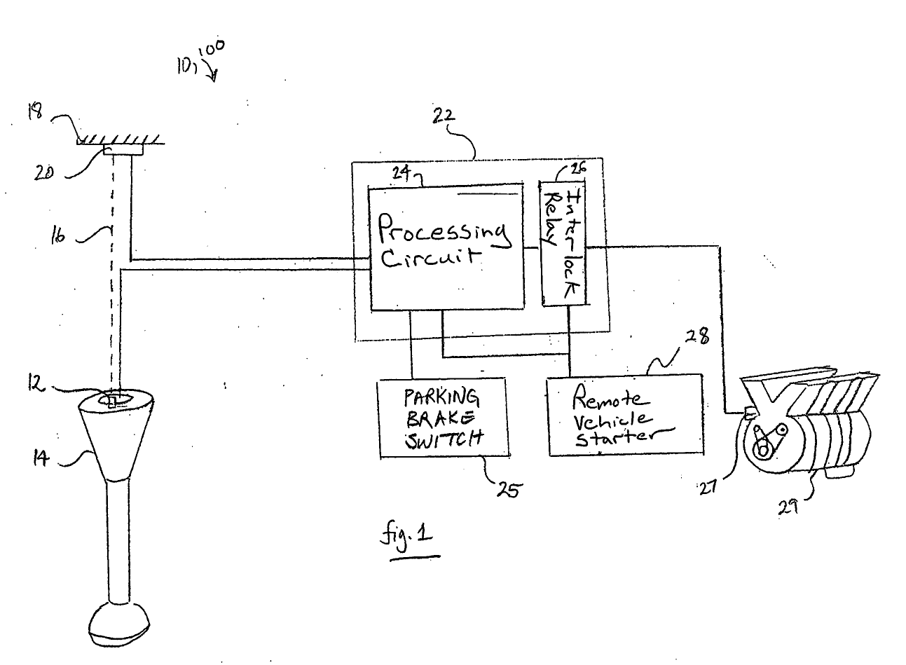

Reference is made to FIG. 1 which shows a neutral sensing switch in accordance with an example embodiment of the present invention. The neutral sensing switch 10 includes a transmitter 12 mounted on top of a shift lever 14 for transmitting energy or trigger pulses 16 towards the vehicle head liner 18 on which is mounted a receiver 20. The receiver 20 is positioned such that the trigger pulses 16 from the transmitter 12 are incident upon the receiver 20 when the shift lever 14 is in the neutral position.

The transmitter 12 and the receiver 20 are both connected to a controller circuit 22 having a processing circuitry 24 coupled to an interlock relay 26. The interlock relay 26 is coupled to a remote vehicle starter 28 and activates the vehicle ignition system 27 to start the engine 29. The remote vehicle starter 28 is also coupled to the processing circuitry 24 and instigates the neutral detection procedure.

The transmitter 12 initiates trigger pulses 16 when a vehicle start request is communicated to the remote vehicle starter 28 by a remote user and the vehicle's parking brake 25 has been engaged. Such request is generally conveyed to the remote vehicle starter 28 by way of a key fob transmitter sending a radio signal encoded with an identification code to the remote vehicle starter 28, so the remote vehicle starter 28 may authorize the remote start-up of the vehicle engine. Based upon the pattern of pulses received at the receiver 20, the processing circuitry 24 assesses whether the shift lever 14 is in the neutral position and activates the vehicle ignition system 27 so that the vehicle can be safely started.

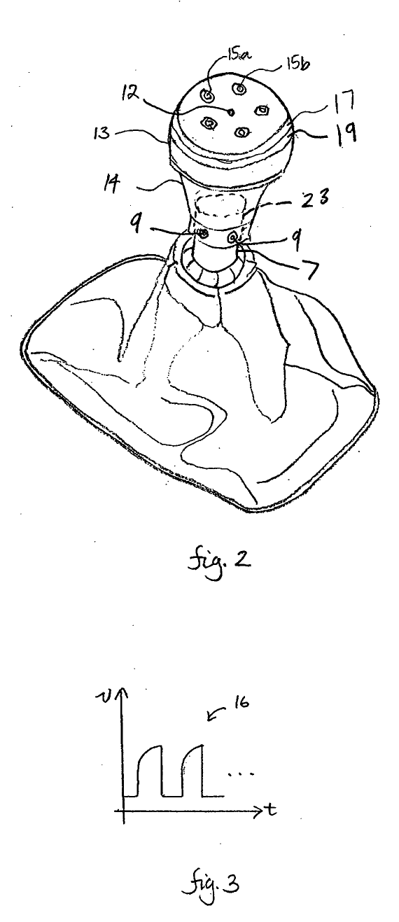

FIG. 2 is a diagrammatic view of the neutral sensing switch transmitter 12 mounted in a vehicle's shift knob 13. The shift knob 13 has a small hole 12 in which the transmitter 12 is fitted, and adjustment screws 15a, 15b etc. The adjustment screws 15a, 15b, allow the transmitter 12 to be positioned such that the trigger pulses 16 are directly aimed towards the receiver 20, irrespective of where the receiver 20 is actually located. In one example embodiment, the transmitter 12 is in a disc-like housing 17 that sits on a resilient compressible disc 19 on the top of a remainder of the shift knob 13. The adjustment screws 15a, 15b, etc are spaced around a periphery of the housing 17, and have shafts that pass through the housing 17, through the compressible disc 19 and into the lower portion of the shift knob, thereby securing the housing 17 to the rest of the shit-knob. The adjustment screws can be adjusted to control the degree of compression of the resilient compressible disc 19 in order to “aim” the transmitter 12. In various embodiments, different aiming systems may be used, and in some embodiments the transmitter housing 17 may be integral with the rest of the shift knob and resilient disc 19 omitted. In some embodiments, the transmitter 12 may be pre-manufactured in the shift knob 13 and the entire unit available as a replacement shift knob universally adapted for mounting on most vehicle's shift lever. For example, the shift knob 13 could include a plurality of inwardly directed set screws 9 around a lower end thereof for engaging the shift lever 7, an upper end of which is received in downward facing opening 23 of the shift knob. In some embodiments, opening 23 may be threaded for a specific size of shift knob. In some embodiments, a further universal shift knob adaptor may be provided as an interface between the shift knob 13 and shift lever 7.

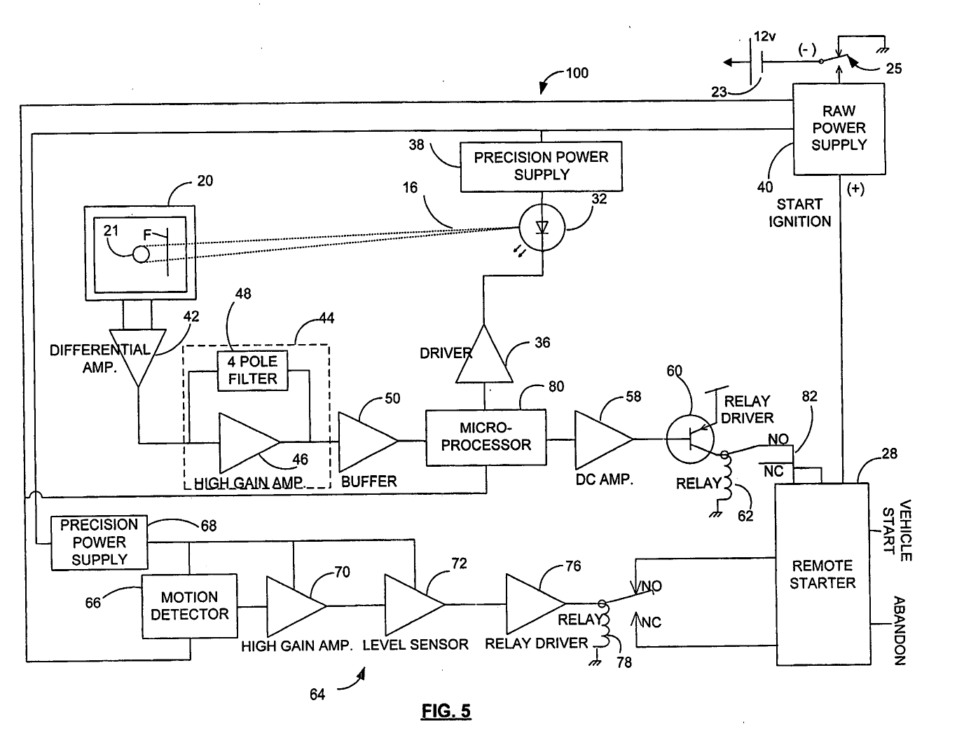

Referring now to FIG. 4, the individual components of an example embodiment of the present invention are described in more detail. The transmitter 12 generally comprises a laser diode 32 for generating trigger pulses 16 aimed at the receiver 20, and a laser driver circuit 30 that includes (1) a pulse generator 34; (2) a driver 36; and a (3) precision power supply 38. The transmitter driver circuit 30 may be co-located with the laser diode 32 on the shift lever 14.

The laser diode 32 can be any type of commercially available laser producing devices having a finely focused beam, such as a VCSEL (Vertical Cavity Surface Emitting Laser). Other emitting devices of the type commonly found in laser pointing devices may be used in various embodiments, as may LEDs and high intensity LEDs. In an example embodiment, the transmitter 12 is capable of generating pulses that are finely focussed to within a 3-5 mm circle at a distance of approximately 1 m. The receiver 20 may include a Mylar filter F to eliminate incident light rays of a frequency above or below the specified frequency of the laser diode 32. Advantageously, the filter F may be dyed into the surface of the receiver 20 during production. The laser diode 32 may also be equipped with a collimating lens L with an externally threadably adjustable focus mount in order to focus the trigger pulses 16 to a minimal spot on the receiver 20 of approximately 3 mm diameter.

The pulse generator 34 has its power line connected to a raw power supply 40 of the neutral sensing switch 10. The raw power supply 40 provides power to the various components of the neutral sensing switch 10 of the present invention and is energized by the “start ignition” signal from the remote vehicle starter 28 when the parking brake switch 25 is in the engaged position. In an example embodiment, a precision power supply 38 is coupled to the laser diode 32 to supply power to the laser diode 32 free of any interferences commonly found on the vehicle battery 23.

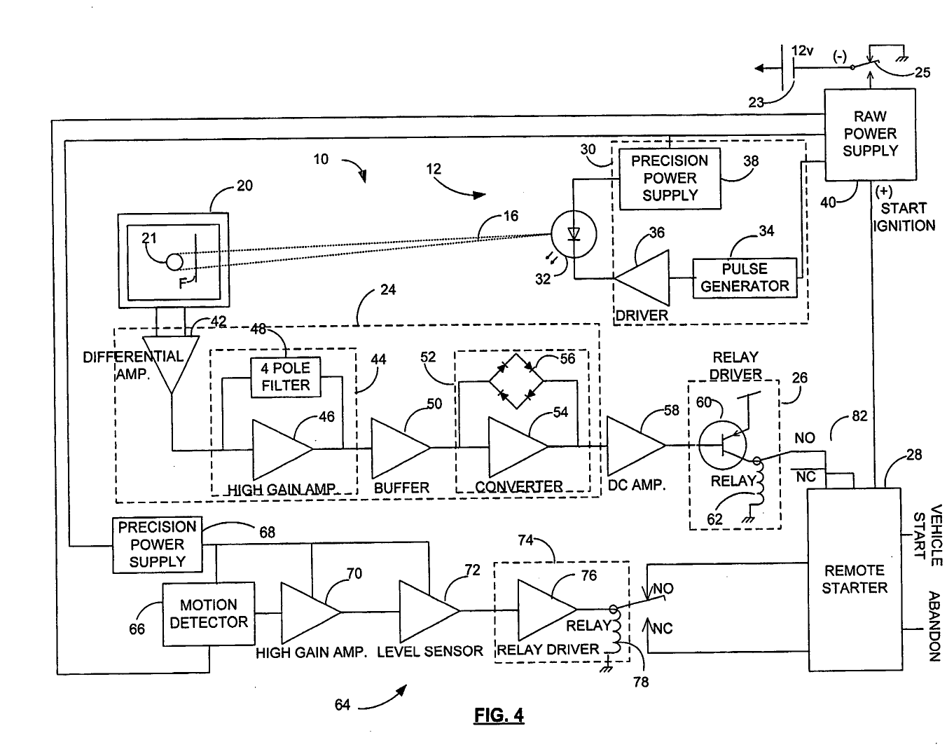

The output of the pulse generator 34 is connected to the driver 36 which triggers the laser diode 32 to produce trigger pulses 16 based on the pulse generator's 34 output. FIG. 3 is shows a graphical representation of the trigger pulses 16. The trigger pulses 16 are preferably shaped and configured to prevent false detection at the receiver 20. The trigger pulses 16 generated by the laser diode 32 as shown in FIG. 3 are preferably highly focused and at a frequency which is not a prime multiple of 50 Hz or 60 Hz to avoid interference from commonly found appliances which typically use 50 Hz or 60 Hz alternating current lines.

The receiver 20 is mounted on the vehicle's head liner 18 or any other interior panels such as a door panel or an instrument panel that is in a horizontal line with or higher than the shift knob, using securing mechanisms such as, but not limited to, velcro, double sided adhesive tape, and/or quick setting adhesive. Alternatively, the receiver 20 may be built into an existing vehicle fixture such as a dome light by a skilled installer or by the automotive manufacturer. The receiver 20 has a target area 21 comprising a light detection device such as an amorphous silicone cell or a silicone solar cell plate which is sensitive to the trigger pulses 16 and outputs a control signal from 0 to 5 volts corresponding to the trigger pulses 16. By way of non-limiting example, in one application, the target area 21 is a 4000:1 ratio with respect to the transmitter beam width—for instance, for beam widths of 3 mm or less in diameter, the target area is sized approximately 32×48 mm. The tight focus or extreme narrow beam width assists in eliminating false positive start signals by preventing a larger beam width from generating a control signal as if the trigger pulse 16 lands partially on the target area's 21 definition of neutral. In example embodiments, the target area 21 is optimally sized to compensate for misalignments in the position of the neutral on the transmission due to normal wear of the shift linkage or discrepancies during the manufacturing of the vehicle, reducing the possibility of the receiver and transmitter becoming misaligned and requiring re-calibration.

The control signal generated by the receiver 20 is outputted to the first stage of the processing circuitry 24, namely a differential amplifier 42. The differential amplifier 42 avoids the problem of the control voltage being constant. The output of the differential amplifier 42 is coupled to the input of a filter stage 44 comprising a high gain amplifier 46 and an nth-order filter stage 48. The filter stage 48 is responsible for identifying the trigger pulses based on the control voltage. In the presently described embodiment of the invention, the filter stage 48 is a Twin “T” notch filter placed into the inverting pass of a High-Gain Operating Amplifier 46.

The output of the filter stage 44 is coupled to a buffer 50 which is the second stage of the processing circuitry 24. The buffer 50 serves to further stabilize the control voltage about the center of the power supply voltage and reduces the noise component of the voltage signal.

The third stage of the processing circuitry 24 includes an operational rectifier stage 52 which comprises a full wave bridge 56 which is in the negative feedback loop of an operational amplifier 54 which can be described as a low level signal rectifier (an absolute value circuit) 56. The output of the buffer 50 is coupled to the input of the rectifier stage 52. Based on the value of the control voltage, the output of the rectifier stage 52 is either: (1) a logical “no start” signal if the control voltage is below the threshold level indicating that the transmission is engaged and not in a neutral position; or (2) a logical “start” signal if the control voltage corresponds to the neutral position of the transmission.

The fourth stage of the processing circuitry 24 is an amplifier 58 the input thereof is connected to the output of the rectifier stage 52. The output of the amplifier 58 is fed to a relay driver 60 which actuates the relay 62 based on the signal at the output of the amplifier 58. Together, the relay driver 60 and the relay 62 comprise the interlock switch 26 of the neutral sensing switch 10. The output of the interlock switch 26 is coupled to the input of a remote vehicle starter 28 responsible for firing up the vehicle's engine. The remote vehicle starter 28 is also coupled to the pulse generator 34 in order to command the pulse generator 34 to send trigger pulses 16 when a remote start-up is requested by a user.

If the logical signal of the rectifier stage 52 is a “start” signal, the amplifier 58 drives the relay driver 60, causing the relay 62 to actuate and instruct the remote vehicle starter 28 to start the vehicle's engine. In the event that the logical signal is a “no start” condition relating to the non-neutral transmission, the relay 62 remains unenergized and will not allow the remote vehicle starter 28 to start the engine.

Preferably, the interlock switch 26 terminates the activation of the vehicle ignition system upon being satisfied that the vehicle has successfully started. As a result, once the vehicle has been safely started and in operation, the interlock switch 26 is disabled and disengaged from the remote vehicle starter 28 to prevent the unsafe condition of a subsequent accidental or inappropriate remote start-up of the vehicle engine when the vehicle's transmission is an engaged position other than neutral.

There is also shown in FIG. 4 a vehicle movement sensor, indicated generally by reference 64, employed in combination with the neutral sensing switch 10 which acts as a back up safety device should any electronic malfunction occur in either the neutral sensing switch 10 or the remote vehicle starter 28.

The vehicle movement sensor 64 is an engine kill switch is driven by a motion detector 66 such as an accelerometer or a Hall effect sensor. The motion detector 66 is powered by a precision power supply 68 coupled to the raw power supply 40 which removes any interference commonly found in the main power line of the vehicle. The output signal from the motion detector 66 is sent to a high gain amplifier 70 whose input is connected to the output of the motion detector 66. The output of the high gain amplifier 70 is in turn connected to a level sensor 72 which measures the output level of the motion detector 66. The output of the level sensor 72 is connected to an interlock relay 74 comprising a relay driver 76 coupled to a relay 78. The output of the interlock relay 74 is fed to the remote vehicle starter 28 and represents a “start” or “no-start” condition upon which the remote vehicle starter 28 determines if the vehicle should continue to be started or in the alternative, the start-up sequence should be aborted.

In operation, when the amplified signal at the output of the level sensor 72 reaches a threshold value, it causes the level sensor 72 to power up the relay driver 74 coupled to the level sensor 72, thereby causing the relay 78 to close and send a ground signal via the remote starter hood pin switch 82 to the remote vehicle starter 28 to immediately shut down the vehicle engine. The threshold value that triggers the level sensor may be adjusted by the installer by a series of dip switches provided in the level sensor 72. The threshold value may be determined by experimentation by starting the car in gear and observing which dip switch setting shuts off the engine.

The vehicle movement sensor 64 of the present invention may be incorporated with the neutral sensing switch 10 in the same unit, or it may be a separate module that operates as a redundant safely switch in cooperation with the neutral sensing switch 10.

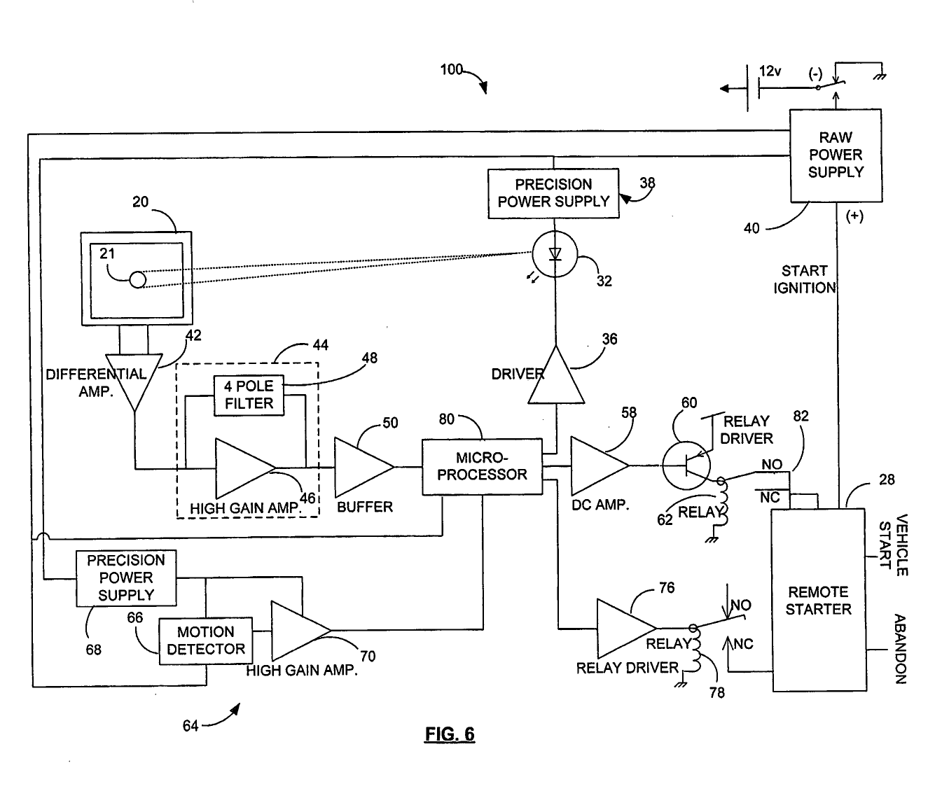

FIG. 5 shows, indicated generally by reference 100, an alternative embodiment of the neutral sensing switch of the present invention. Switch 100 is similar to switch 10, except that rectifier stage 52 and pulse generator 34 are implemented using a microprocessor 80. Similar to switch 10, the neutral sensing switch 100 includes a laser diode 32 for transmitting trigger pulses 16 towards a target area 21 of a receiver 20. Power to the laser diode 32 is provided by a precision power supply 38 coupled to the raw power supply 40 that is coupled to the “start ignition” line of the remote vehicle starter 28 and the parking brake switch 25.

The control signal generated by the receiver 20 in response to the trigger pulses 16 is communicated to a differential amplifier 42 to discern any variations thereof. The signal at the output of the differential amplifier 42 is then sent to a filter stage 44 comprising an n^{th}-order filter 48 and a high gain amplifier 46. The filter stage 44 is coupled to a buffer 50, which serves to stabilize the signal at the output of the filter stage 44. The output of the buffer 50 is coupled to microprocessor 80. The microprocessor 80 receives the signal at the output of the buffer 50 and is programmed to determine whether the vehicle's transmission is in the neutral position based upon the value of this signal. The microprocessor 80 is also coupled to receive a power signal from the power supply 40 when the remote starter is remotely activated—when the power signal is present, the microprocessor generates pulses that are provided through driver 36 to the laser emitter 32. If the microprocessor determines (based on input from buffer 50) that the transmission is in the neutral position at the same time that the microprocessor is driving laser emitter 32, the microprocessor sends a signal to the amplifier 58 for charging to instruct a relay driver 60 to energize a relay 62. By monitoring the status of the relay 62, a remote car starter 28 determines whether it is safe to start the vehicle's engine. In order to prevent a false start-up when the vehicle is moving, the vehicle movement sensor 64 is also coupled to the remote car starter 28 which senses the vehicle's motion and aborts the start-up procedure if the vehicle is not in a stationary position.

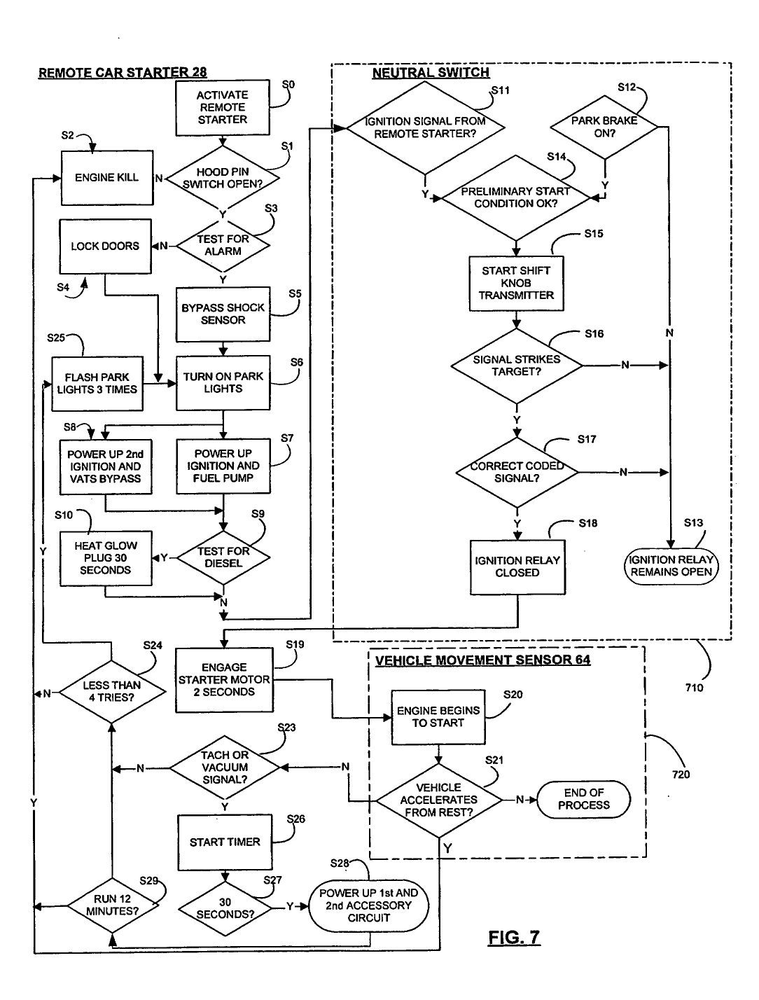

FIG. 6 shows a further embodiment of microprocessor based switch 100, which is similar to the embodiment of FIG. 5 except that the level sensor 72 of sensor circuit 64 is also integrated into microprocessor 80. Thus, in the embodiment of FIG. 6, the microprocessor 80 receives an input signal from the motion detector 66 (through amp 70) and is operatively connected to drive relay 78 through relay driver 76 based on such input signal.

FIG. 7 shows, according to one example embodiment, the general steps involved in remote start-up of a vehicle's engine using a remote vehicle starter equipped with the neutral sensing switch and vehicle movement sensor of the present invention as shown in FIGS. 4, 5 and 6. The steps shown in block 710 are generally carried out by remote sensor switch 10, 100, the steps in block 720 are generally carried out by movement sensor circuit 64, and the remaining steps are carried out by the remote vehicle starter 28. The remote vehicle starter 28 is initially activated in response to a signal from a remote transmitter (such as a key fob transmitter) operated by the user (Step S0). Upon activation, the remote vehicle starter 28 seeks to determine whether the hood of the vehicle is open by checking the status of the vehicle's hood pin switch (Step S1). If the hood is open, the remote vehicle starter 28 immediately aborts the engine start-up procedure (Step S2). However, if the hood is closed, the remote vehicle starter 28 checks to assess whether the vehicle is equipped with an alarm system (Step S3). If the vehicle does not have an alarm system, the remote vehicle starter 28 locks the vehicle's doors (Step S4) and proceeds to Step S6. If the vehicle has an alarm system, the remote vehicle starter 28 proceeds to bypass the vehicle's shock sensor (Step S5) and then proceed to Step S6. In step S6, the park lights are turned on to indicate the by-standers or the user that the vehicle is in the process of being remotely started.

Depending on the whether the vehicle is equipped with a Vehicle Activation Transmitter (VAT) system, the remote vehicle starter 28 then powers up the vehicle ignition and fuel pump (Step S7), or powers up the vehicle's 2_{nd} ignition and bypasses the VAT system (Step S8). The remote vehicle starter 28 checks to determine whether the vehicle uses diesel fuel (Step S9). In the event that the vehicle is diesel, the remote vehicle starter 28 then the performs the further step of causing the heat glow plug to heat up for 30 seconds (Step S10). At this juncture, an ignition start is communicated through power supply 40 to the pulse generator 34 (or microprocessor 80) of the neutral sensor switch 10 which effectively initiates the neutral detection scheme of the present invention (Step S11).

Upon initialization of the pulse generator 34 (or microprocessor 80) to send trigger pulses 16, the neutral sensor 10 checks the status of the parking brake (via switch 25) (Step S12). In the event that the parking brake is not engaged, the relay 62 remains open (Step S13). In the case of microprocessor controlled neutral switch 100, the microprocessor may also check to see if the battery signal exceeds a threshold voltage, for example 9 volts, and if not, abort the start process. If the vehicle's parking brake has been activated (and, if monitored, the battery voltage signal is above the threshold), the transmitter 12 sends trigger pulses 16 towards the receiver 20 (Steps S14, S15). If the trigger pulses 16 do not strike the target area 21 (Step S16), relay 62 remains open (Step S13) and the vehicle is not started. If pulses are detected at the target area 21, a check is made by processing circuitry 24 to determine if such pulses match a predetermined pattern (for example the waveform of FIG. 3) (Step S17). If the received pulse is the correct coded signal, the ignition relay 62 is energized (Step S18). If the received pulse does not match the correct coded signal, the ignition relay 62 remains open (step S13).

Once the ignition relay 62 is energized, the vehicle starter 28 attempts to start the vehicle's engine (Step S19). As the engine begins to start (Step S20), the vehicle movement sensor 64 checks whether the vehicle is accelerating from the rest position (Step S21) and if so abruptly shuts off the engine (Step S22) by closing relay 78 thereby grounding the ignition and aborting any further sequence of the remote starter 28. Thus, movement sensor 64 provides a further check to ensure that the vehicle is not being started in gear.

If the vehicle is determined in Step S21 to not be in motion, the remote car starter 28 checks to see if the vehicle has been successfully started by checking, for example, an “engine running” signal at the vehicle's distributor, ignition coil or manifold vacuum to the tachometer or vacuum. (Step S23). If the “engine running” signal indicates that the engine is not operating, the remote vehicle starter 28 attempts at least 4 times to start the engine by going back to Step S6, each time flashing the park lights 3 times (Step S25). If after 4 tries the vehicle is still not starting, the remote vehicle starter 28 then stops trying to start the engine.

In the event that the “engine running” signal indicates that the engine is running, a timer is set (Step S26) for 30 seconds (Step S27) prior to powering up the vehicle's accessories such as the climate control system (Step S28). If the engine is left running for a threshold time, for example 12 minutes, without a user inserting a key manually into the ignition, the remote vehicle starter 28 automatically shuts off the engine (Step 29).

The present invention may be embodied in other specific forms without departing from the spirit or essential characteristics thereof. Certain adaptations and modifications of the invention will be obvious to those skilled in the art. Although the neutral sensing switch herein was described for use with manual transmission vehicles, the switch can also be used to safely start vehicles equipped with automatic transmission remote starter systems. Furthermore, while the foregoing description is based on laser operating transmitter and receiver, the neutral sensing switch of the present invention may also be implemented by other types of transmitters and receivers wherein the trigger pulses can be narrowly focused, such as RF or microwave devices. In some embodiments, the location of the transmitter and receiver may be switched, with the receiver located on the shift knob and the transmitter located above the shift knob in the headliner, for example. In some embodiments, the transmitter 12 and/or receiver 20 may include separate power sources and communicate through wireless connections with the rest of the neutral switch circuit.

Accordingly, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A sensing switch for detecting the position of a vehicle transmission shift lever having a shift lever knob at an upper end thereof, comprising:
a receiver having a predetermined target area;
a transmitter for transmitting a directed beam of trigger signals;
one of the receiver and transmitter being mounted to the shift lever knob and the other of the receiver and transmitter being mounted in the vehicle at a location spaced apart from the shift lever knob so that the transmitted trigger signals are directed towards the target area when the shift lever knob is in a predetermined position; and
a controller coupled to the receiver for determining, based on the trigger signals received by the receiver, if the shift lever knob is in the predetermined position and if so generating a predetermined signal.

2. The sensing switch of claim 1 wherein the other of the receiver and transmitter is mounted at a location that is horizontal with or above the shift lever knob.

3. The sensing switch of claim 2 wherein the other of the receiver and transmitter is mounted in one of one of a head liner, a door panel or an instrument panel of the vehicle.

4. The sensing switch of claim 1 wherein the transmitter includes a narrow beam emitting device mounted to an upper end of shift lever knob to direct the trigger signals in an upward direction, the receiver being mounted to the interior of the vehicle in a location higher than the transmitter.

5. The sensing switch of claim 4 wherein the target area is secured to a head liner of the vehicle.

6. The sensing switch of claim 1 wherein the predetermined position corresponds to a neutral position of the shift lever and the predetermined signal is for application to a remote vehicle starter for enabling the remote vehicle starter to start an engine of the vehicle.

7. The sensing switch of claim 6 further including a motion sensor for detecting motion of the vehicle and generating a predetermined kill engine signal if motion is detected thereby during start up of an engine of the vehicle.

8. The sensing switch of claim 1 wherein the controller is configured for checking if the signals received by the receiver meet predetermined characteristics for confirming that the received signals are trigger signals.

9. The sensing switch of claim 8 wherein the trigger pulses have a frequency selected to fall outside of frequencies generally associated with the transmission of electrical power.

10. The sensing switch of claim 1 wherein the transmitter includes a fine beam producing laser device for generating the trigger signals, and the receiver includes an optical sensor.

11. The sensing device of claim 10 wherein the laser device includes a focasable collimating lens for adjusting a width of the fine beam produced by the laser device.

12. A sensing switch for detecting the position of a transmission shift lever in a vehicle, comprising:
a receiver having a predetermined target area, the receiver being configured for mounting to a target area in the vehicle;
a shift knob handle having embedded therein a transmitter for transmitting a directed beam of trigger signals and having a lower end for engaging an upper end of a shift lever; and
a controller coupled to the receiver for determining, based on the trigger signals received by the receiver, if the shift lever is in the predetermined position and if so generating a predetermined signal.

13. The sensing switch of claim 12 including a vehicle movement sensor for detecting movement of the vehicle upon attempted startup of the engine and generating a kill engine signal if vehicle motion is detected.

14. The sensing switch of claim 13 including a remote vehicle starter coupled for receiving the predetermined signal and the kill engine signal, wherein the predetermined signal is for signaling to the remote vehicle starter that the vehicle shift lever is in a neutral position for enabling the remote vehicle starter to start an engine of the vehicle, the remote vehicle starter being configured for ceasing any attempted startup of the engine upon receiving the kill engine signal.

15. The sensing switch of claim 12 including a detector for detecting and generating a brake signal for the controller if a parking brake of the vehicle is in a braking position, the controller configured to not generate the predetermined signal if the brake signal is absent.

16. The sensing switch of claim 12 wherein the transmitter includes a narrow beam laser emitting device housed within the shift knob handle.

17. The sensing switch of claim 12 wherein the shift knob handle includes a housing, a resilient member, the housing being secured to the lower end of the shift knob handle by a plurality of adjustment screws, the resilient member being located between the housing and the lower end and compressible through adjustment of the adjustment screws, the transmitter being mounted in the housing and being aim-able through adjustment of the adjustment screws.

18. The sensing switch of claim 17 wherein the housing has an upper surface from which the transmitter directs the trigger pulses.

19. A neutral sensing system for use with a remote vehicle starter in a manual transmission vehicle to detect of the vehicle is in neutral, comprising:
a sensing switch for determining, upon receiving an activating signal, if a transmission shift lever is in a predetermined physical location that is associated with neutral, and if so generating a “start” signal to signal the remote vehicle starter to commence starting the vehicle engine; and
a movement detection device for detecting, upon receiving an activating signal, if the vehicle is moving, and if so generating a “kill engine” signal to override the “start” signal and cause the vehicle starter to abort starting the vehicle engine.

20. The neutral sensing system of claim 19 wherein the sensing switch includes:
a receiver having a predetermined target area;
a transmitter for transmitting a directed beam of trigger signals;
one of the receiver and transmitter being mounted to the shift lever and the other of the receiver and transmitter being mounted in a location higher that the shift lever so that the transmitted trigger signals are directed towards the target area when the shift lever is in the predetermined location; and
a controller coupled to the receiver for determining, based on the trigger signals received by the receiver, if the shift lever is in the predetermined location and if so generating the “start” signal.
